(19) United States
(12) Patent Application Publication
(10) Pub. No.: US 2014/0176438 A1
(43) Pub. Date: Jun. 26, 2014

(54) HANDHELD DEVICE AND DISPLAY CONTROL METHOD

(71) Applicant: HON HAI PRECISION INDUSTRY CO., LTD., New Taipei (TW)

(72) Inventor: HO-LEUNG CHEUNG, Santa Clara, CA (US)

(73) Assignee: HON HAI PRECISION INDUSTRY CO., LTD., New Taipei (TW)

(21) Appl. No.: 13/855,645

(22) Filed: Apr. 2, 2013

(30) Foreign Application Priority Data
Dec. 26, 2012 (TW) 101150279

(51) Int. Cl. G06F 3/0346

(52) U.S. Cl. CPC G06F 3/0346
USPC 345/158

(57) ABSTRACT

An exemplary display control method is provided. The method determines whether the handheld device is being held by a right hand or a left hand according to an inclined angle of a top of a handheld device relative to the Y axis detected by a detection unit. The method then controls a display unit to display information in a first display mode when the handheld device is being held by a right hand, and controls the display unit to display information in a second display mode when the handheld device is being held by a left hand.

### BACKGROUND

1. Technical Field

The present disclosure relates to handheld devices, and particularly, to a handheld device capable of automatically changing display modes according to users' habit and a display control method.

2. Description of Related Art

Some handheld devices (e.g., smart phones) include a relatively larger touch display. However, if the displayed icons are displayed in a default mode, for example, displayed on the left side of the touch display. When a user holds the handheld device with a left hand, usually, a top of the handheld device is inclined toward the right side relative to a Y axis, for the user to conveniently view displayed information. If the displayed icons are distributed on the left side of the touch display, the user need to turn his/her head to the left side or look sideways to view the display icons, which may be not comfortable for the user. Therefore, it is desirable for a handheld device to be able to resolve the above problem.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram illustrating a handheld device, in accordance with an exemplary embodiment.

FIG. 2 is a schematic view showing that information is displayed on a display unit of the handheld device of FIG. 1 in a first display mode.

FIG. 3 is a schematic view showing that information is displayed on the display unit of the handheld device of FIG. 1 in a second display mode.

FIG. 4 is a flowchart of a display control method, in accordance with an exemplary embodiment.

### DETAILED DESCRIPTION

The embodiments of the present disclosure are described with reference to the accompanying drawings.

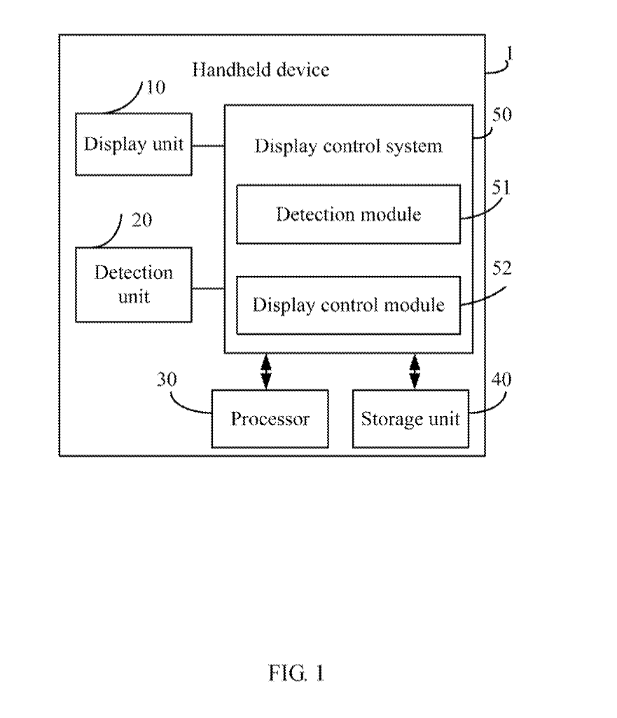

FIG. 1 illustrates a handheld device 1 that can automatically change display modes of information on a display unit 10 of the handheld device 1 to satisfy the needs of both a user holding the handheld device 1 with a left hand and a user holding the handheld device 1 with a right hand.

The handheld device 1 includes a detection unit 20, a processor 30, a storage unit 40, and a display control system 50. In the embodiment, the detection unit 20 may be an angle sensor, a gyroscope, or an angle detector. The detection unit 20 is configured to detect an inclined angle of a top of the handheld device 1 relative to a Y axis. In the embodiment, the display control system 50 includes a detection module 51 and a display control module 52. One or more programs of the above function modules may be stored in the storage unit 20 and executed by the processor 10. In general, the word “module,” as used herein, refers to logic embodied in hardware or firmware, or to a collection of software instructions, written in a programming language. The software instructions in the modules may be embedded in firmware, such as in an erasable programmable read-only memory (EPROM) device. The modules described herein may be implemented as either software and/or hardware modules and may be stored in any type of computer-readable medium or other storage device.

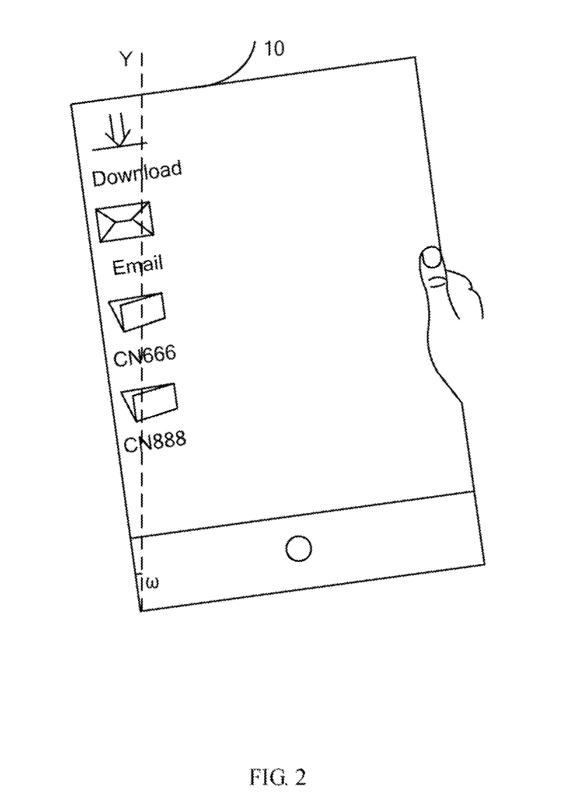

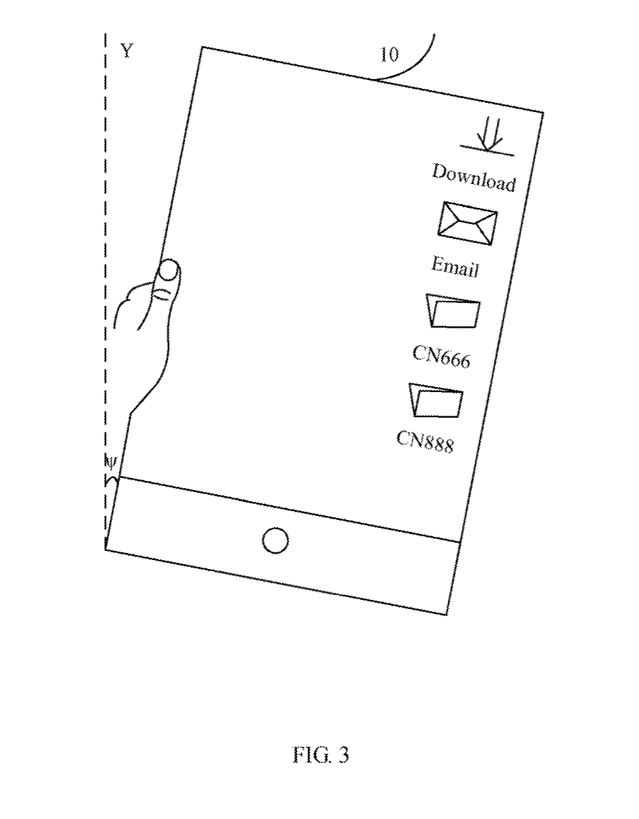

The detection module 51 is configured to determine whether the handheld device 1 is being held by a right hand or a left hand according to the inclined angle of the top of the handheld device 1 relative to the Y axis detected by the detection unit 20. Generally, when a user holds the handheld device 1 with a right hand, the user inclines the top of the handheld device 1 relative to the Y axis toward the left side, for convenient viewing of the information displayed on the display unit 10. For example, in FIG. 2, the handheld device 1 is held by a right hand, the top of the handheld device 1 is on the left side of the Y axis, an angle co represents the top of the handheld device 1 inclining relative to the Y axis toward left side. In addition, when a user holds the handheld device 1 with a left hand, the user inclines the top of the handheld device 1 relative to the Y axis toward the right side, for convenient viewing of the information displayed on the display unit 10. For example, in FIG. 3, the handheld device 1 is held by a left hand, the top of the handheld device 1 is on the right side of the Y axis, an angle ψ represents the top of the handheld device 1 inclining relative to the Y axis toward right side. Thus, when the detection unit 20 detects that the inclined angle of the top of the handheld device 1 relative to the Y axis is toward the left side, the detection module 51 determines that the handheld device 1 is being held by a right hand, and when the detection unit 20 detects that the inclined angle of the top of the handheld device 1 relative to the Y axis is toward the right side, the detection module 51 determines that the handheld device 1 is being held by a left hand.

The display control module 52 is configured to control the display unit 10 to display information in a first display mode when the handheld device 1 is being held by a right hand, and control the display unit 10 to display information in a second display mode when the handheld device 1 is being held by a left hand. In the embodiment, in the first display mode, the information is displayed on the left side of the display unit 10 (see FIG. 2), and in the second display mode, the information is displayed on the right side of the display unit 10 (see FIG. 3). The information can be the shortcuts of the applications, time, or prompt information.

In an alternative embodiment, the handheld device 1 further records favorites, and changes the information displayed on the display unit 10 according to the favorites and user's habit, for example, whether holds the handheld device 100 with a left hand or a right hand. For example, if the recorded favorite is watching football match through a network television application, the handheld device 1 displays the shortcut of the network television application on the shortcut menu. If it is detected that a user habit is holding the handheld device 1 with a left hand, the handheld device 1 displays the shortcut of the network television application on the right side of the display unit 10.

In another embodiment, a server (not shown) communicating with the handheld device 1 records the favorites, for example, a certain content usually downloaded. The handheld device 1 transmits identity information to the server in response to a manual operation. The server then determines which information the user of the handheld device 1 wants to obtain according to the recorded favorites, and transmits the determined information to the handheld device 1. The handheld device 1 changes the information displayed on the display unit 10 according to the information received from the server and users' habit, for example, whether holds the handheld device 100 with a right hand or left hand. For example, a user who holds the handheld device with a right hand usually downloads the applications about art. When the handheld device 100 communicates with the server, the server automatically installs one or more applications about art on the handheld device 1 or automatically transmits a prompt to prompt the user of available applications about art. The handheld device 1 can display the shortcut of the application about art or the prompt to the application on the left side of the display unit 10.

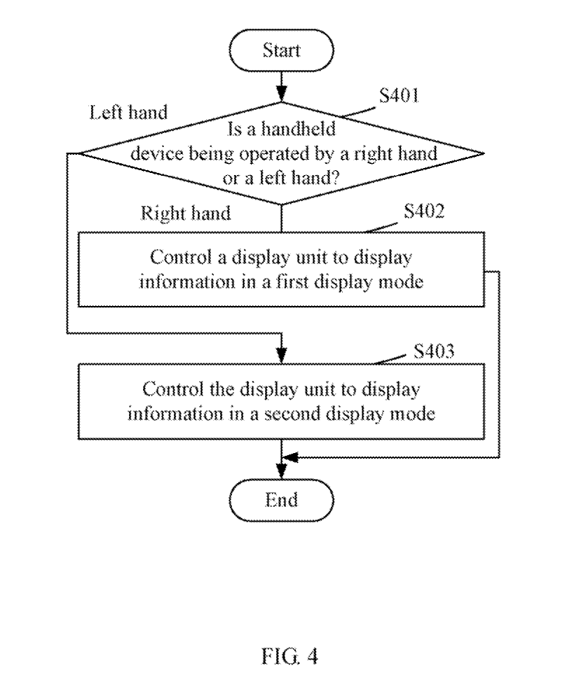

FIG. 4 shows a display control method in accordance with an exemplary embodiment.

In step S401, the detection module 51 determines whether a handheld device 1 is being held by a right hand or a left hand according to the inclined angle of the top of the handheld device 1 relative to a Y axis detected by a detection unit 20. When the handheld device 1 is being held by a right hand, the procedure goes to step S402. When the handheld device 1 is being held by a left hand, the procedure goes to step S403. In detail, when the detection unit 20 detects that the inclined angle of the top of the handheld device 1 relative to the Y axis is toward left side, the detection module 51 determines that the handheld device 1 is being held by a right hand. In addition, when the detection unit 20 detects that the inclined angle of the top of the handheld device 1 relative to the Y axis is toward right side, the detection module 51 determines that the handheld device 1 is being held by a left hand.

In step S402, the display control module 52 controls a display unit 10 to display information in a first display mode. In the first display mode, the information is displayed on the left side of the display unit 10.

In step S403, the display control module 52 controls the display unit 10 to display information in a second display mode. In the second display mode, the information is displayed on the right side of the display unit 10.

Although the present disclosure has been specifically described on the basis of an exemplary embodiment thereof, the disclosure is not to be construed as being limited thereto. Various changes or modifications may be made to the embodiment without departing from the scope and spirit of the disclosure.

What is claimed is:

1. A handheld device comprising:
a detection unit configured to detect an inclined angle of a top of the handheld device relative to a Y axis;
a display unit;
a storage unit;
a processor;
a plurality of programs stored in the storage unit, executable by the processor, the programs comprising:
a detection module operable to determine whether the handheld device is being held by a right hand or a left hand according to the inclined angle of the top of the handheld device relative to the Y axis detected by the detection unit; and
a display control module operable to control the display unit to display information in a first display mode when the handheld device is being held by a right hand, and control the display unit to display information in a second display mode when the handheld device is being held by a left hand.

2. The handheld device as described in claim 1, wherein when the detection unit detects that the inclined angle of the top of the handheld device relative to the Y axis is toward the left side, the detection module determines that the handheld device is being held by a right hand; when the detection unit detects that the inclined angle of the top of the handheld device relative to the Y axis is toward the right side, the detection module determines that the handheld device is being held by a left hand.

3. The handheld device as described in claim 1, wherein the information is displayed on the left side of the display unit in the first display mode; and the information is displayed on the right side of the display unit in the second display mode.

4. The handheld device as described in claim 1, wherein the detection unit is an angle sensor, gyroscope, or an angle detector.

5. A display control method implemented by a handheld device, the handheld device comprising a display unit and a detection unit configured to detect an inclined angle of a top of the handheld device relative to a Y axis, the method comprises:
determining whether the handheld device is being held by a right hand or a left hand according to the inclined angle of the top of the handheld device relative to the Y axis detected by the detection unit; and
controlling the display unit to display information in a first display mode when the handheld device is being held by a right hand, and controlling the display unit to display information in a second display mode when the handheld device is being held by a left hand.

6. The display control method as described in claim 5, wherein the method further comprises:
determining that the handheld device is being held by a right hand when the detection unit detects that the inclined angle of the handheld device relative to the Y axis is toward the left side; and
determining that the handheld device is being held by a left hand when the detection unit detects that the inclined angle of the handheld device relative to the Y axis is toward the right side.

7. The display control method as described in claim 5, wherein the information is displayed on the left side of the display unit in the first display mode; and the information is displayed on the right side of the display unit in the second display mode.

8. The display control method as described in claim 5, wherein the detection unit is an angle sensor, gyroscope, or an angle detector.

9. A display control system applied on a handheld device, the handheld device comprising a detection unit, a display unit, and a processor, the detection unit being configured to detect an inclined angle of a top of the handheld device relative to a Y axis, the display control system comprising:
a detection module operable to determine whether the handheld device is being held by a right hand or a left hand according to the inclined angle of the top of the handheld device relative to the Y axis detected by the detection unit via the processor; and
a display control module operable to control the display unit to display information in a first display mode via the processor when the handheld device is being held by a right hand, and control the display unit to display information in a second display mode via the processor when the handheld device is being held by a left hand.

10. The display control system as described in claim 9, wherein when the detection unit detects that the inclined angle of the top of the handheld device relative to the Y axis is toward the left side, the detection module determines that the handheld device is being held by a right hand via the processor; when the detection unit detects that the inclined angle of the top of the handheld device relative to the Y axis is toward the right side, the detection module determines that the handheld device is being held by a left hand via the processor.

11. The display control system as described in claim 9, wherein the information is displayed on the left side of the display unit in the first display mode; and the information is displayed on the right side of the display unit in the second display mode.
